(19) United States
(12) Patent Application Publication
(10) Pub. No.: US 2006/0090708 A1
(43) Pub. Date: May 4, 2006

(54) Fish barrier

(76) Inventors: Paul Henry Patrick, Milton (CA); Otto Herrmann, Ancaster (CA)

Correspondence Address: LAW OFFICES OF WILLIAM H. HOLT, 12311 Harbor Drive, Woodbridge, VA, 22192, US

(21) Appl. No.: 11/260,237

(22) Filed: Oct. 28, 2005

(30) Foreign Application Priority Data
Oct. 28, 2004 (GB) 04 23906.7

(51) Int. Cl. A01K 61/00; E02B 8/08

(52) U.S. Cl. 119/219

(57) ABSTRACT

A barrier for diverting fish from a water flow channel such as an intake (12) consists of a dyke (10) enclosing the water intake, and extending at least the entire depth of the body of water. There are pipes (20) extending between opposite sides of the dyke (10), of diameter at least 800 mm (31 inches). The inlet end of each pipe (20) communicates with the body of water through one or more inlet ducts (26) of width no more than 600 mm (24 inches), this being a duct size to which the fish from the body of water have an aversion. Each inlet duct (26) may also be aligned at least 45° below the longitudinal axis of the pipe (20). The confined space, the resulting darkness, and the change in water flow direction, all have the effect of discouraging fish from entering the ducts. The number of pipes (20) should be sufficiently large that the intake velocity will be less than 150 mm/s (0.5 ft/s), to minimise entrainment or impingement of fish.

This invention relates to a barrier for diverting fish from water intakes for dams, power plants, and other industrial plant that use large quantities of water, or from water outflows from such plants.

A wide variety of users extract water from bodies of water in the natural environment, such as the sea, lakes, rivers or reservoirs. Water is extracted through water intakes for example for turbines, cooling systems, industrial use, potable water supplies, irrigation canals and desalination plants; similarly there are plants from which water is discharged into the environment through water outlets. In such cases it is usually desirable to prevent or minimise the passage of fish from the body of water into the water intake or outlet, and a variety of different systems for diverting fish and other aquatic life from water intakes have been proposed. For example U.S. Pat. No. 4,169,792 (Dovel) describes a water intake device with a cylindrical rotatable screen which is designed to guide or carry fish and debris away, along with a backwashing device to remove them from the screen. U.S. Pat. No. 5,385,428 (Taft et al) describes a fish diversion apparatus that uses a plane screen. However, screens may become blocked with debris or by the growth of algae or shellfish, so that maintenance can be expensive.

In this specification the term water flow channel refers to a water inlet or a water outlet.

According to the present invention there is provided a barrier for diverting fish from a water flow channel adjacent to a body of water, the barrier comprising a dyke enclosing the water flow channel and extending at least the entire depth of the body of water adjacent to the water flow channel, the dyke being provided with passages therethrough extending between opposite sides of the dyke, each passage having a minimum dimension greater than 800 mm (31 inches), and communicating with the body of water at the side remote from the water flow channel through at least one flow duct whose width is such that fish in the body of water have an aversion to entering a duct of such a size, and, if the water flow direction is into the flow duct from the body of water, the number of passages and the flow area of each flow duct being such that the flow velocity is less than 150 mm/sec.

At least in the context of the Great Lakes (in North America), the flow duct or ducts are preferably of width no more than 600 mm (24 inches), as this has been found to be the largest duct size to which the Great Lakes fish have an aversion. Fish that are customarily living in open water tend to have an aversion to entering confined spaces. It will be appreciated that fish in different environments, for example in the sea, may have an aversion to ducts of a different size. For a water inlet the intake velocity should be less than 150 mm/s (0.5 ft/s), to minimise entrainment or impingement of fish.

To minimise the effects of biofouling on the hydraulic performance of the barrier, the passages have a minimum dimension greater than 800 mm (31 inches). This is significantly larger than the preferable size of the flow ducts, and it is therefore desirable to have a plurality of the flow ducts communicating with such a passage.

Preferably each flow duct has a longitudinal axis aligned at least 45° below the longitudinal axis of the passage. The difference in alignment between the flow ducts and the associated passage ensures that the openings will appear dark to any fish and therefore even less attractive to most types of fish. Furthermore, many types of fish have an aversion to the change of flow direction that this difference in alignment causes. Preferably each flow duct is aligned downwardly, to reduce still further the visual cues for fish or mobile fish larvae approaching the flow duct, and to minimise the accumulation of silt or debris in the flow duct.

Preferably each flow duct is provided with a plastic liner or sleeve, to minimise biofouling at the entrance to the passages. Such liners can be easy to install, and are subsequently easy to remove and replace, so that maintenance is simplified. It is expected that replacement would be required no more than once every few years. Plastic liners or sleeves may also be provided at the other ends of the passages, i.e. at the ends closer to the water flow channel, typically extending over a length no more than twice the maximum transverse dimension of the passage. In each case the polymer sleeves may also be coated with an anti-biofouling polymer coating.

Where there is a difference in alignment between the passage and the flow ducts, each flow duct is preferably at least 150 mm long, more preferably about 300 mm or 600 mm long, but preferably no longer than 1200 mm. It is inconvenient to have to insert sleeves into longer ducts. However, where there is no such difference in alignment then each flow duct is preferably longer than these lengths, preferably more than 1.0 m although preferably no more than 3.0 m, for example 1.5 m or 1.8 m.

In the preferred embodiment each passage is a cylindrical pipe and is of diameter greater than 1000 mm (39.4 inches), for example 1067 mm (42 inches). Preferably the minimum dimension of each passage is no larger than 2000 mm, more preferably no larger than 1500 mm.

The invention will now be further and more particularly described, by way of example only, with reference to the accompanying drawings in which:

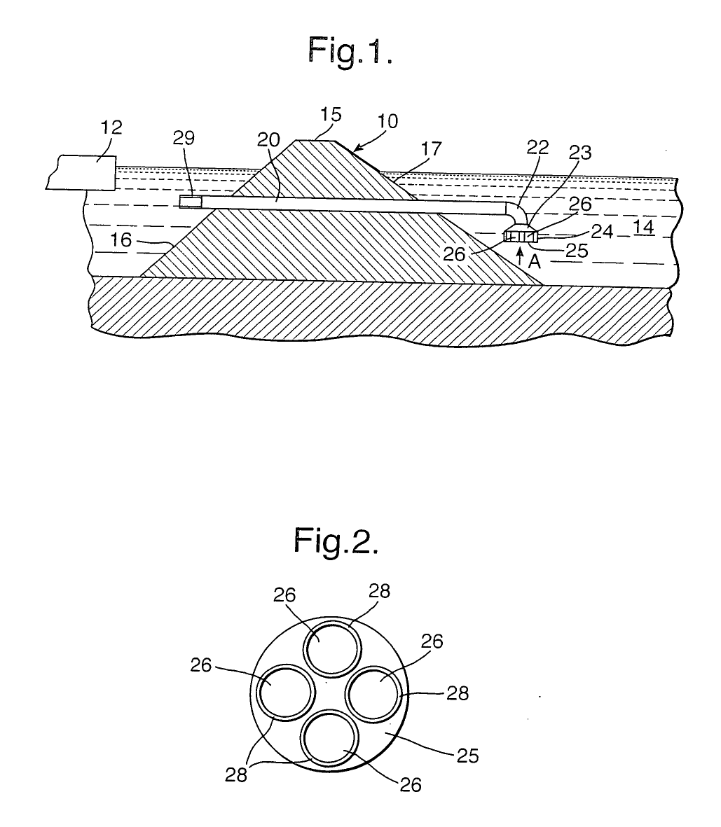

FIG. 1 shows a cross-sectional view of a dyke forming part of a water intake structure; and

FIG. 2 shows a view in the direction of arrow A of FIG. 1, showing the inlet section of the dyke to a larger scale.

Referring now to FIG. 1 there is shown a cross-sectional view of a dyke 10 to inhibit fish from reaching a water intake 12 of a power station (not shown). The power station takes water from a lake 14. The intake structure includes two parallel piers or groynes (not shown) that are impermeable to fish and which extend from the shore out into the lake 14, the ends being about 230 m apart and being linked by the dyke 10. The dyke 10 is sufficiently high to be about 0.5 m higher than the highest water level expected in the lake 14, with a flat top 15 of width 3.6 m, and with sloping sides 16, 17 to minimise erosion by waves, and may for example be made of concrete.

Below the lowest expected water level there are sixty steel pipes 20 extending horizontally through the dyke 10, each pipe 20 being of internal diameter 1050 mm (41 inches), and being sufficiently long to protrude beyond the sloping sides 16, 17 of the dyke 10 on each side. These pipes 20 are equally spaced along the length of the dyke 10, being spaced 11 m apart from each other. In each case, on the side closest to the water intake 12 the pipe 20 is open. On the other side, the pipe 20 communicates via a 90° elbow 22 and a conical linking section 23 with a 300 mm-long inlet section 24 of pipe of internal diameter 1660 mm closed by a steel plate 25 at its lower end. The inlet section 24 encloses four open-ended steel pipes 26 each 300 mm long and of internal diameter 600 mm aligned with four corresponding 600 mm diameter apertures in the steel plate 25, as shown in FIG. 2. The elbow 22 is arranged so that the longitudinal axes of the steel pipes 26 are vertical.

Each pipe 26 in the inlet section 24 is lined with a plastic sleeve 28 (shown in FIG. 2, the thickness being exaggerated for clarity) of high-density polypropylene along its entire length. A 2 m length of plastic sleeve 29 is also provided at the open end of the pipe 20 (at the end nearest the intake 12). These sleeves 28, 29 inhibit biofouling by algae and by shellfish such as mussels.

The number of pipes 20, and their dimensions, are such that the water flow velocities are less than 150 mm/s, which minimises entrainment and impingement of fish. Because the pipes 26 in the inlet section 24 face downward, they are dark inside, which reduces the visual cues for fish approaching them. The low light levels within the pipes 26 discourage most types of fish, particularly those most common in open water, from entering the pipes 26. This may be enhanced by lining the pipes 26 with sleeves 28 that are dark-coloured, for example black. Furthermore, water from the lake 14 initially flowing towards the inlet section 24 in a generally horizontal direction must change its direction of flow through 90° to enter the pipes 26, and this change of flow direction is disconcerting to many fish. The result is that very few fish enter the inlet section 24 and therefore very few fish pass through the dyke 10.

The dyke 10 also avoids problems of biofouling. One potential biofouling problem is that of algal growth. For example in Lake Michigan various filamentous algae grow attached to rocks and other solid surfaces along the shore, the dominant species usually being Ulothrix zonata and Cladophora glomerata. The former usually predominates in the early spring, while the latter becomes predominant in the later spring and summer. Cladophora tends to be the more robust species, and more readily clogs pores and structures. If these algae become detached, for example due to waves, they can form mats near the surface of the water. However, with the dyke 10, the approach velocity (away from the immediate vicinity of the inlet section 24) is less than 30 mm/s, so that entrainment of such mats is unlikely to occur. The large diameter of the pipes 20 passing through the dyke 10 means that they are unlikely to become clogged by growing algae, and in any event the very low light levels within the pipe 20 are insufficient for photosynthesis so that any algae there will tend to die. Furthermore the plastic sleeves 28, 29 minimise the attachment of such algae to the ends of the water flow path; this may be augmented by the use of anti-fouling coatings.

Another potential biofouling problem is that of mussel growth. For example in Lake Michigan zebra mussels are well-established, and in Lake Ontario and Lake Erie there is also the related species the quagga mussel. The constant flow of water through the pipe 20 provides a potential habitat for colonisation by such mussel species. However, the anti-fouling coating and plastic inserts 28 minimise mussel attachment at the entrance to the water flow path. The low light level within the pipe 20 inhibits the growth of mussels, as they appear to require some light for optimal growth. Furthermore, the large diameter of the pipe 20 is such that even if the pipe 20 becomes covered with mussels to a depth of 75 mm the flow rate through the pipe is scarcely affected.

As explained above, the dyke 10 is arranged to suppress the problems of bio-fouling. Maintenance is comparatively straightforward, essentially necessitating the replacement of the sleeves 28 and 29 every four or five years. It will be appreciated that there are no moving parts, and no parts that are expected to become significantly fouled during use.

It will be appreciated that a fish barrier may differ from the dyke 10 while remaining within the scope of the invention. For example, the length of the dyke 10 and the number of pipes 20 will depend upon the required water flow at the intake 12, and the height of the dyke 10 depends upon the depth of the body of water. Where the dyke is not exposed to waves, it may have a different cross-sectional shape, for example having substantially vertical sides rather than the sloping faces 16 and 17. The dyke itself may in some situations be constructed of materials other than concrete, for example it might be built of rocks, as long as it is impermeable to fish. Because the top of the dyke is above water level, the dyke may be used as a causeway.

It should be understood that in some cases it may be possible to use inlet pipes 26 of a smaller diameter, and so even less attractive to fish, as long as the intake velocity does not exceed 150 mm/s, and that the number of pipes 26 in the inlet section 24 may be different from that described above. The polymer inserts 28 and 29 may be of a material other than the polypropylene mentioned above. To suppress biofouling there may also be a plastic sheet on the outside of the closure plate 25; and this may be integral with the sleeves 28.

It will be further appreciated that similar problems can arise where water is discharged. For example, at discharges of cooling water from power stations, fish may be attracted by the warm water and become killed by thermal shocks or by accidental releases of chemicals such as chlorine into the cooling system. A fish barrier as described above, comprising pipes 20 installed within a dyke 10, would also be applicable in this context too.

We claim:

1. A barrier for diverting fish from a water flow channel adjacent to a body of water, the barrier comprising a dyke enclosing the water flow channel and extending at least the entire depth of the body of water adjacent to the flow channel, the dyke being provided with passages therethrough extending between opposite sides of the dyke, each passage having a minimum dimension greater than 800 mm, and communicating with the body of water at the side remote from the water flow channel through at least one flow duct whose width is such that fish in the body of water have an aversion to entering a duct of such a size, and, if the water flow direction is into the flow duct from the body of water, the number of passages and the flow area of each flow duct being such that the flow velocity is less than 150 mm/sec.

2. A barrier as claimed in claim 1 wherein each passage communicates with the body of water at the side remote from the water flow channel through a plurality of flow ducts.

3. A barrier as claimed in claim 1 wherein each flow duct is aligned at an angle to the longitudinal axis of the passage and is at least 150 mm long.

4. A barrier as claimed in claim 1 wherein each flow duct has a longitudinal axis aligned at least 45° below the longitudinal axis of the passage.

5. A barrier as claimed in claim 4 wherein each flow duct is aligned downwardly.

6. A barrier as claimed in claim 1 wherein each flow duct is aligned with the longitudinal axis of the passage and is at least 1.0 m long.

7. A barrier as claimed in claim 1 wherein each flow duct is provided with means to minimise biofouling.

8. A barrier as claimed in claim 1 wherein each passage is a cylindrical pipe and is of diameter greater than 1000 mm (39.4 inches).

9. A barrier as claimed in claim 1 wherein the minimum dimension of each passage is no larger than 2000 mm.
